(19) United States
(12) Patent Application Publication
(10) Pub. No.: US 2025/0215745 A1
(43) Pub. Date: Jul. 3, 2025

(54) VARIABLE-FORCE COIL SPRING AND PULLING CORD CONTROL DEVICE

(71) Applicant: UNION WINNER INTERNATIONAL CO., LTD., TAIPEI CITY (TW)

(72) Inventor: Ming-Tsung PAI, CAOTUN TOWNSHIP (TW)

(73) Assignee: UNION WINNER INTERNATIONAL CO., LTD., TAIPEI CITY (TW)

(21) Appl. No.: 18/612,506

(22) Filed: Mar. 21, 2024

(30) Foreign Application Priority Data
Jan. 3, 2024 (TW) 113200101

(51) Int. Cl. E06B 9/322; E06B 9/262

(52) U.S. Cl. CPC E06B 9/322; E06B 9/262; E06B 2009/2625; E06B 2009/3225

(57) ABSTRACT

A variable-force coil spring includes a central hole and a band coiled from the central hole outward. The band includes an inner end located in the central hole, an outer end, and an outer end section from the outer end to a first length, a first force descending section generating gradually descending elastically restoring force from the first length to a second length, a second force descending section generating gradually descending elastically restoring force from the second length to a third length, and a force maintaining section generating maintained elastically restoring force from the third length to a fourth length, which are successively arranged from the outer end toward the inner end in order. The present invention further provides a pulling cord control device including a variable-force coil spring. The present invention is applicable to a window blind to make it convenient and easy to be upward folded smoothly.

### BACKGROUND OF THE INVENTION

### 1. Field of the Invention

The present invention relates generally to coil springs and more particularly, to a variable-force coil spring having specific variation in elastically restoring force thereof, thereby applicable to a window blind, and a pulling cord control device including a variable-force coil spring.

### 2. Description of the Related Art

Referring to U.S. patent Ser. No. 11/193,328B2, a conventional window blind includes a headrail, and a pulling cord control device disposed in the headrail. The pulling cord control device includes a frame, and two cord winding wheels and two coil spring winding wheels, which are disposed in the frame. The coil spring winding wheels are engaged with each other and collectively arranged for a coil spring to be wound thereon. The cord winding wheels are engaged with the coil spring winding wheels respectively, and each arranged for a pulling cord to be wound thereon. The pulling cords pass through two sides of the frame respectively, and pass through the headrail and slats of the window blind so as to be connected with the bottom rail of the window blind. Through the effect of the pulling cord control device, the user can pull the bottom rail of the window blind to control the opening and closing of the window blind, and can stop the bottom rail at any position between the uppermost position, where the window blind is fully folded, and the lowermost position, where the window blind is fully unfolded.

More specifically speaking, the coil spring in the above-described pulling cord control device is usually provided at different parts thereof with different torque by the configuration design of the coil spring in width, thickness or other aspects thereof, so as to provide elastically restoring force corresponding to the open and close conditions of the window blind, so that the bottom rail of the window blind can be stopped at any position between the uppermost position and the lowermost position when being pulled downward. Besides, when the bottom rail of the window blind is located at the lowermost position, as long as the bottom rail is slightly pushed upward by the user, the bottom rail will be pulled upward by the elastically restoring force of the coil spring, bringing the effects of convenience and effort-saving.

However, the configuration design of the conventional coil spring is liable to bring a problem that when the bottom rail is located at the lowermost position, the elastically restoring force of the coil spring is too small to resist the friction of the pulling cord, causing non-smoothness to the window blind being upward folded and the resulting numerous times of trying to the user to make it. Alternatively, the window blind may even malfunction, thereby unable to be upward folded. Alternatively, the elastically restoring force may be too large, resulting in rebound (similar to constant-force spring).

### SUMMARY OF THE INVENTION

The present invention has been accomplished in view of the above-noted circumstances. It is a primary objective of the present invention to provide a variable-force coil spring which is applicable to a pulling cord control device of a window blind, and makes the window blind convenient and easy to be upward folded by the user smoothly.

In view of the above-noted circumstances, it is another objective of the present invention to provide a pulling cord control device which can make a window blind convenient and easy to be upward folded by the user smoothly.

To attain the above objective, the variable-force coil spring provided by the present invention includes a central hole, and a band coiled from the central hole outward. The band includes an inner end located in the central hole, an outer end, and a plurality of sections arranged from the outer end toward the inner end successively. The plurality of sections, from the outer end toward the inner end in order, includes an outer end section, a first force descending section, a second force descending section, and a force maintaining section. The outer end section is from the outer end to a first length. The first force descending section generates gradually descending elastically restoring force from the first length to a second length. The second force descending section generates gradually descending elastically restoring force from the second length to a third length. The force maintaining section generates maintained elastically restoring force from the third length to a fourth length.

To attain the above objective, the pulling cord control device provided by the present invention includes a housing, at least one cord winding wheel and a coil spring winding wheel, which are disposed in the housing capably of rotating each other, and a variable-force coil spring. The variable-force coil spring includes a central hole, and a band coiled from the central hole outward. The band includes an inner end located in the central hole, an outer end, and a plurality of sections arranged from the outer end toward the inner end successively. The variable-force coil spring is arranged to be affected by an external force to be wound onto the coil spring winding wheel from an initial installed status. When the variable-force coil spring is in the initial installed status, the outer end of the band is disposed on the coil spring winding wheel. The sections of the band wound onto the coil spring winding wheel from the initial installed status in order includes a first force descending section, a second force descending section and a force maintaining section. The first force descending section generates gradually descending elastically restoring force from a first length to a second length. The second force descending section generates gradually descending elastically restoring force from the second length to a third length. The force maintaining section generates maintained elastically restoring force from the third length to a fourth length.

Further speaking, the maintained elastically restoring force mentioned in the present invention refers to that the elastically restoring force keeps consistent or slightly ascends. More specifically speaking, the force maintaining section generates consistent elastically restoring force from the third length to the fourth length. Alternatively, the force maintaining section generates gradually ascending elastically restoring force from the third length to the fourth length, and the ascending rate of the elastically restoring force of the force maintaining section is smaller than the descending rates of the elastically restoring force of the first and second force descending sections.

As a result, in the condition that the variable-force coil spring of the present invention is applied to a pulling cord control device of a window blind, when the window blind is in the fully folded status, which means the bottom rail of the window blind is located at the uppermost position, the bottom rail carries all slats of the window blind, and meanwhile the largest force is required for pulling the bottom rail. Correspondingly, the variable-force coil spring generates the largest elastically restoring force at the first length for pulling the bottom rail at the uppermost position, so that the window blind is maintained in the fully folded status. In the process of the bottom rail being pulled downward, the amount of the slats carried by the bottom rail gradually decreases, so the force required for pulling the bottom rail also gradually decreases. Correspondingly, the elastically restoring force of the first and second force descending sections of the variable-force coil spring gradually decreases to make the total weight of the bottom rail and the slats carried thereby, the friction of the pulling cord and the elastically restoring force of the variable-force coil spring balance to the greatest extent, thereby enabling the bottom rail to be stopped at any position in the process of being pulled downward. The fourth length of the variable-force coil spring is arranged to correspond to the lowermost position of the bottom rail, and the third length is arranged to correspond to the part adjacent to the lowermost position. The elastically restoring force of the variable-force coil spring of the present invention doesn't continue descending from the third length to the fourth length, but keeps consistent or slightly ascends, which still enables the bottom rail to be stopped at the lowermost position. Besides, when the user wants to fold the window blind upward and thereby slightly pushes the bottom rail located at the lowermost position upward, the elastically restoring force of the variable-force coil spring of the present invention is ensured to pull the window blind upward, thereby making the window blind convenient and easy to be upward folded by the user smoothly.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic front view of a variable-force coil spring according to a preferred embodiment of the present invention.

FIG. 2 is a schematic bottom view of the variable-force coil spring.

FIG. 3 is a schematic planar view of a band for being coiled into the variable-force coil spring.

FIG. 4 is a curve diagram of elastically restoring force to length of the variable-force coil spring.

FIG. 5 is a schematic side view of a window blind using the variable-force coil spring.

FIG. 6 to FIG. 10 are curve diagrams of elastically restoring force to length of variable-force coil springs according to other preferred embodiments of the present invention.

FIG. 11 is a schematic sectional view of a pulling cord control device provided by the present invention.

### DETAILED DESCRIPTION OF THE INVENTION

First of all, it is to be mentioned that same or similar reference numerals used in the following embodiments and the appendix drawings designate same or similar elements or the structural features thereof throughout the specification for the purpose of concise illustration of the present invention. It should be noticed that for the convenience of illustration, the components and the structure shown in the figures are not drawn according to the real scale and amount, and the features mentioned in each embodiment can be applied in the other embodiments if the application is possible in practice.

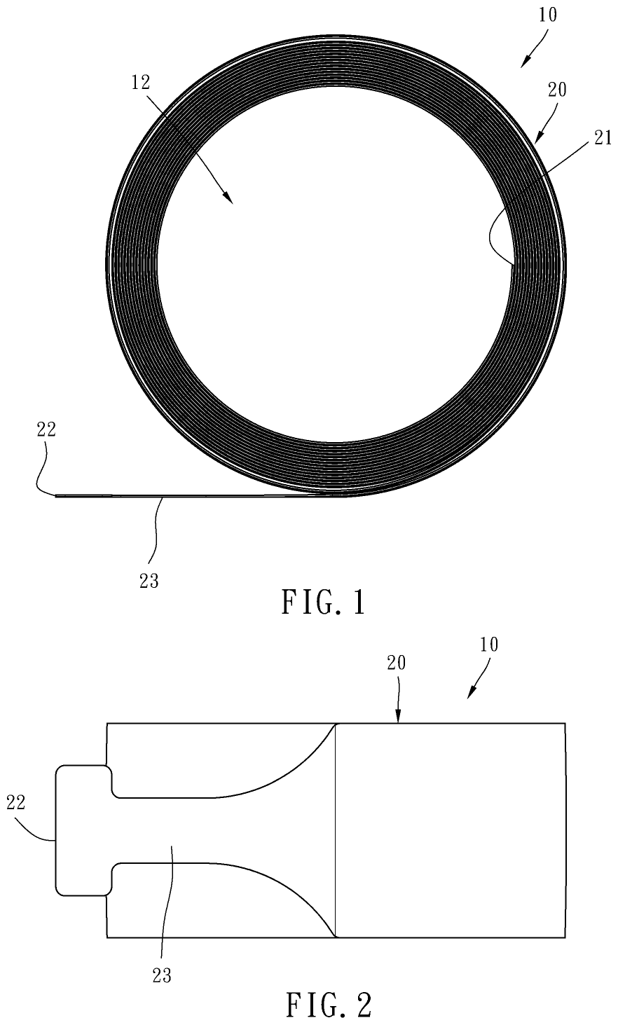

Referring to FIG. 1 and FIG. 2, a variable-force coil spring 10 according to a preferred embodiment of the present invention includes a central hole 12, and a band 20 coiled from the central hole 12 outward.

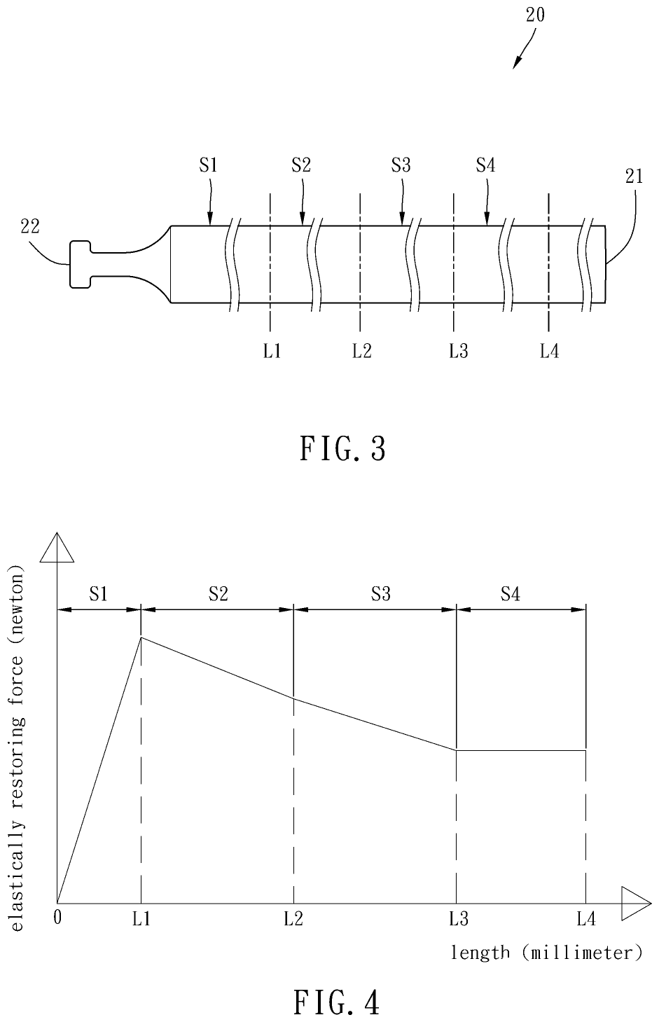

As shown in FIG. 3, the band 20 is originally shaped as a planar elongated stripe, two opposite ends of which are defined as an inner end 21 and an outer end 22. Then, the band 20 is coiled into the variable-force coil spring 10. At this time, the inner end 21 is located on the inside of the variable-force coil spring 10, which means being located in the central hole 12. The outer end 22 is located on the outside of the variable-force coil spring 10. During the manufacture of the band 20, the band 20 can be provided with specific variation in width or thickness thereof, thereby formed with a plurality of sections different in torque. Alternatively, during the band 20 being coiled, the band 20 can be provided with specific variation in curvature thereof, thereby formed with a plurality of sections different in torque.

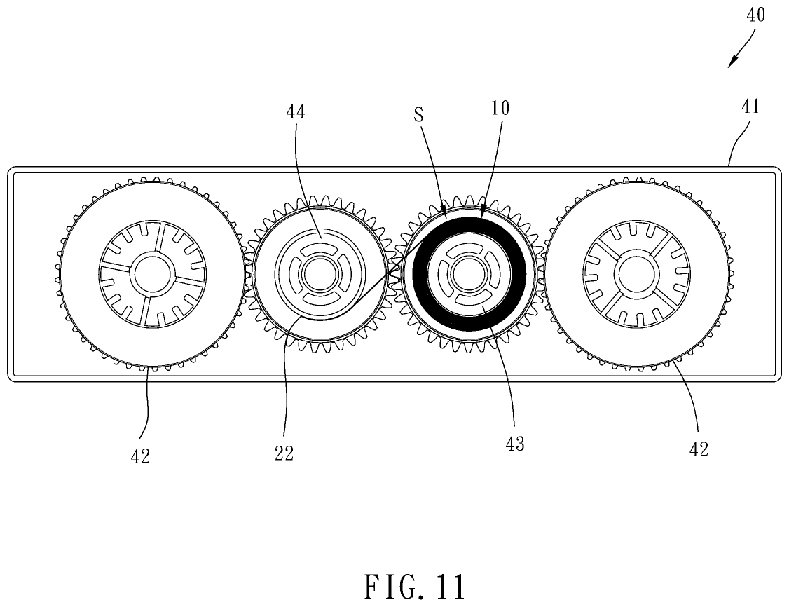

As shown in FIG. 3, the band 20 includes an outer end section S1, a first force descending section S2, a second force descending section S3 and a force maintaining section S4, which are successively arranged from the outer end 22 toward the inner end 21 in order, and correspond to the curve diagram of elastically restoring force to length shown in FIG. 4. In the present invention, any point of the band 20 has its corresponding length, and the length is measured from the outer end 22, which means the length of any point of the band 20 refers to the distance thereof from the outer end 22 in the longitudinal direction. In FIG. 4, the point 0 in length refers to the outer end 22. As shown in FIG. 1 and FIG. 2, the band 20 in this embodiment includes a flat straight part 23 located adjacent to the outer end 22. The flat straight part 23 is a part of the outer end section S1. The flat straight part 23 is not coiled in the process of the band 20 being coiled into the variable-force coil spring 10, thereby still in the flat and straight status. Therefore, the flat straight part 23 will not generate elastically restoring force, which is primarily arranged for the installation of the variable-force coil spring 10. However, the variable-force coil spring of the present invention may include no such flat straight part 23, so that in the condition that the variable-force coil spring 10 is not applied with force, the entire outer end section S1 of the band 20 is wound on the other part of the band 20. Such outer end section S1 can be applied with force to be elastically deformed into flat straight shape for the installation of the variable-force coil spring 10. Once the band 20 starts to be applied with force and thereby elastically deformed, it starts to generate elastically restoring force. The variable-force coil spring 10 of the present invention is primarily applied to a pulling cord control device 40 as shown in FIG. 11. The pulling cord control device includes a housing 41. The housing 41 primarily accommodates at least one cord winding wheel 42, a coil spring sleeving wheel 43, a coil spring winding wheel 44, and the variable-force coil spring 10. The cord winding wheel 42, the coil spring sleeving wheel 43 and the coil spring winding wheel 44 in this embodiment are disposed on different axles, and engaged with each other to have such connected relation that they can rotate each other. However, the pulling cord control device 40 in the present invention may be configured in a way that cord winding wheels 42 are disposed on the same axles with the coil spring sleeving wheel 43 and the coil spring winding wheel 44 respectively, as long as the cord winding wheels 42, the coil spring sleeving wheel 43 and the coil spring winding wheel 44 can rotate each other. The variable-force coil spring 10 is sleeved onto the coil spring sleeving wheel 43, which means the coil spring sleeving wheel 43 is located in the central hole 12 of the variable-force coil spring 10. It is shown in FIG. 11 that the variable-force coil spring 10 is in an initial installed status S. At this time, the outer end 22 of the band 20 is disposed on the coil spring winding wheel 44. The band 20 is affected by an external force to be wound onto the coil spring winding wheel 44 from the initial installed status S. However, the pulling cord control device 40 is unlimited to have the coil spring sleeving wheel 43. The variable-force coil spring 10 may be sleeved onto a shaft or movably disposed in the housing 41. But the configuration design of the variable-force coil spring 10 being sleeved onto the coil spring sleeving wheel 43 makes the variable-force coil spring 10 disposed more stably, and drawn out and retracted back more smoothly.

As shown in FIG. 4, the outer end section S1 is from the outer end 22 to a first length L1, and will generate gradually ascending elastically restoring force. In this embodiment, the elastically restoring force of the outer end section S1 ascends from the outer end 22 to the first length L1 at approximately constant rate, and the ascending rate thereof is large, so in FIG. 4 the length from 0 to the first length L1 corresponds to an upward sloping straight line with a large slope. It can be known from the above description that the outer end section S1 is primarily arranged for the variable-force coil spring 10 to be installed as the initial installed status S shown in FIG. 11. During the installation, the variable-force coil spring 10 is not applied with force in the beginning, and then an external force is applied thereto, making a part of the variable-force coil spring 10 wound onto the coil spring winding wheel 44. Therefore, when the variable-force coil spring 10 is installed onto a testing machine and tested, it will be obtained that the elastically restoring force of the variable-force coil spring 10 fast rises from 0. In other words, no matter the variable-force coil spring 10 has the flat straight part 23 or not, in FIG. 4 the elastically restoring force corresponding to the point 0 in length being 0 refers to the status of the variable-force coil spring 10 not applied with force yet. The fast ascending elastically restoring force corresponding to the length from 0 to the first length L1 in FIG. 4 is generated in the installation process of the variable-force coil spring 10.

Besides, if the testing is performed to the pulling cord control device 40, the variable-force coil spring 10 has been in the initial installed status S in the beginning. Therefore, the testing result will be obtained only for the sections of the band 20 wound onto the coil spring winding wheel 44 from the initial installed status S, which are the first force descending section S2, the second force descending section S3 and the force maintaining section S4 in order, specified in the following.

The first force descending section S2 is from the first length L1 to a second length L2, and will generate gradually descending elastically restoring force. In this embodiment, the elastically restoring force of the first force descending section S2 descends from the first length L1 to the second length L2 at approximately constant rate, and the descending rate thereof is smaller than the ascending rate of the outer end section

S1, so in FIG. 4 the length from the first length L1 to the second length L2 corresponds to a downward sloping line with a relatively smaller slope. The second force descending section S3 is from the second length L2 to a third length L3, and will also generate gradually descending elastically restoring force. The elastically restoring force of the second force descending section S3 descends from the second length L2 to the third length L3 at approximately constant rate, and the descending rate thereof is slightly smaller than the descending rate of the first force descending section S2, so in FIG. 4 the length from the second length L2 to the third length L3 corresponds to a downward sloping straight line with an even slightly smaller slope. The force maintaining section S4 is from the third length L3 to a fourth length L4, and will generate maintained elastically restoring force. In this embodiment, the aforementioned maintained elastically restoring force keeps consistent, which means the force maintaining section S4 generates consistent elastically restoring force from the third length L3 to the fourth length L4, so in FIG. 4 the length from the third length L3 to the fourth length L4 corresponds to a horizontal straight line.

The fourth length L4 is unlimited to be at the inner end 21 of the band 20. There is usually another section between the fourth length L4 and the inner end 21, and the technical features of the present invention doesn't lie therein, so the part after the fourth length L4 is not shown in the curve diagram in the present invention.

When it is mentioned in the present invention that the elastically restoring force ascends at approximately constant rate or descends at approximately constant rate, it refers to that macroscopically the ascending rate or descending rate of the elastically restoring force is approximately fixed. The curve diagram produced by the practical test usually slightly fluctuates rather than present a perfect straight line.

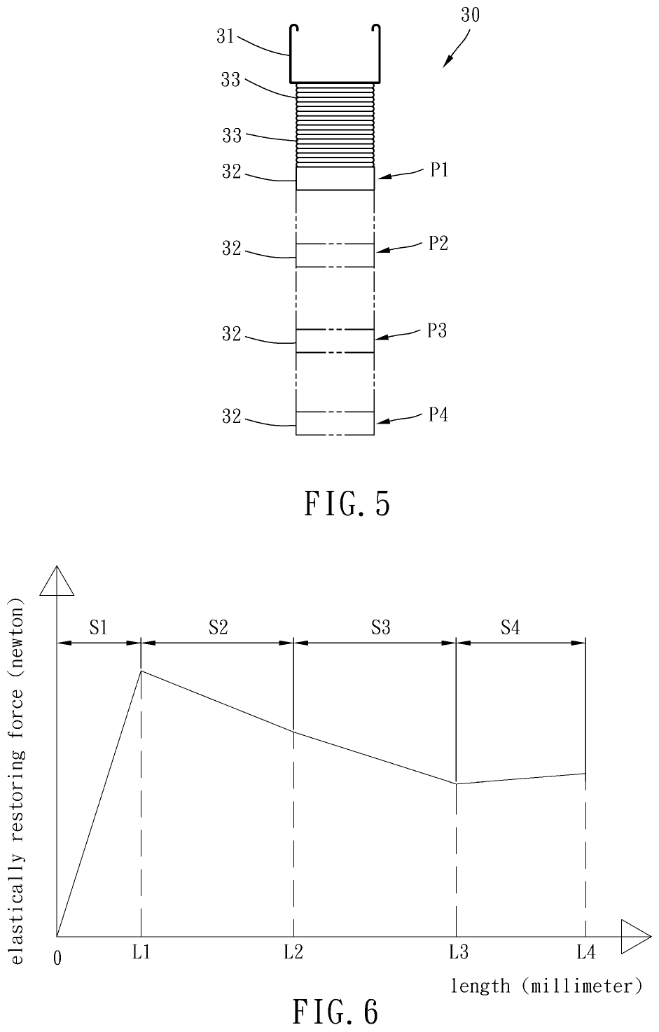

FIG. 5 is a schematic side view of a window blind 30 using the pulling cord control device 40. The pulling cord control device 40 may be disposed in a headrail 31 or a bottom rail 32 of the window blind 30. The user controls the opening and closing of the window blind 30 by controlling the height of the bottom rail 32 of the window blind 30. When the window blind 30 is in the fully folded status, which means the bottom rail 32 is located at the uppermost position P1, the bottom rail 32 carries all slats 33, and meanwhile the largest force is required for pulling the bottom rail 32. Correspondingly, the variable-force coil spring 10 generates the largest elastically restoring force at the first length L1 for pulling the bottom rail 32 at the uppermost position P1, so that the window blind 30 is maintained in the fully folded status. In the process of the bottom rail 32 being pulled downward, the amount of the slats 33 carried by the bottom rail 32 gradually decreases, so the force required for pulling the bottom rail 32 also gradually decreases. Correspondingly, the elastically restoring force of the first and second force descending sections S2 and S3 of the variable-force coil spring 10 gradually decreases to make the total weight of the bottom rail 32 and the slats 33 carried thereby, the friction of the pulling cord and the elastically restoring force of the variable-force coil spring 10 balance to the greatest extent, thereby enabling the bottom rail 32 to be stopped at any position in the process of being pulled downward. Wherein, the second length L2 and the third length L3 of the variable-force coil spring 10 correspond to a first middle position P2 and a second middle position P3 of the bottom rail 32 respectively. The fourth length L4 of the variable-force coil spring 10 corresponds to the lowermost position P4 of the bottom rail 32, and the second middle position P3 corresponding to the third length L3 is located adjacent to the lowermost position P4. The elastically restoring force of the variable-force coil spring 10 doesn't continue descending from the third length L3 to the fourth length L4, but keeps consistent, which still enables the bottom rail 32 to be stopped at the lowermost position P4. Besides, when the user wants to fold the window blind 30 upward and thereby slightly pushes the bottom rail 32 located at the lowermost position P4 upward, the elastically restoring force of the variable-force coil spring 10 is ensured to pull the window blind 30 upward, thereby making the window blind 30 convenient and easy to be upward folded by the user smoothly.

In other embodiments, the maintained elastically restoring force generated by the force maintaining section S4 may not keep consistent, but slightly ascend as shown in FIG. 6, FIG. 8 and FIG. 10, which means the force maintaining section S4 generates gradually ascending elastically restoring force from the third length L3 to the fourth length L4, and the ascending rate of the elastically restoring force of the force maintaining section S4 is smaller than the ascending rate of the elastically restoring force of the outer end section S1 and the descending rates of the elastically restoring force of the first and second force descending sections S2 and S3. Therefore, in FIG. 6, FIG. 8 and FIG. 10, the length from the third length L3 to the fourth length L4 corresponds to an upward sloping straight line with the smallest slope. Such design also ensures the elastically restoring force of the variable-force coil spring 10 to pull the window blind 30 upward, thereby making the window blind 30 convenient and easy to be folded upward by the user smoothly.

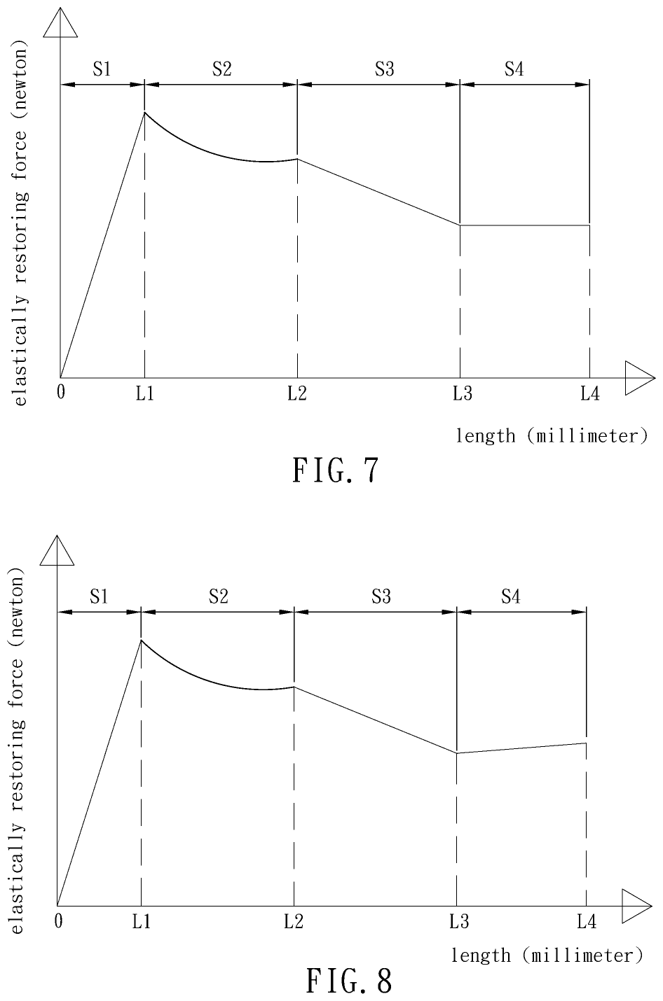

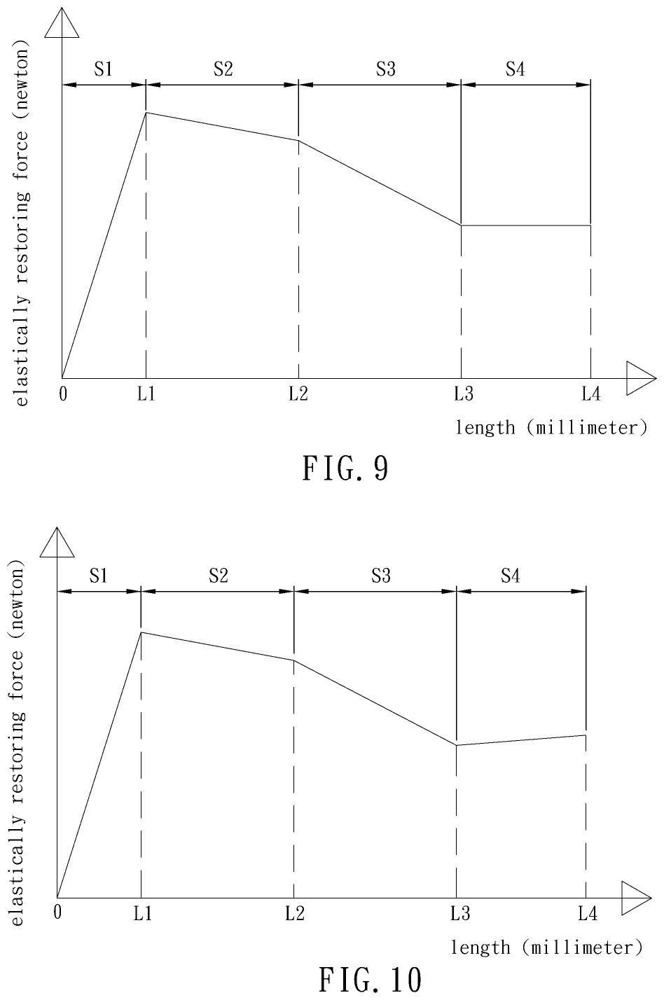

In other embodiments, as shown in FIG. 7 to FIG. 10, the descending rate of the elastically restoring force of the first force descending section S2 may be smaller than the descending rate of the elastically restoring force of the second force descending section S3. In FIG. 7 and FIG. 8, the elastically restoring force of the first force descending section S2 non-linearly descends first quickly and then slowly, so the length from the first length L1 to the second length L2 corresponds to an arc with a descending trend. It can be seen that when it is mentioned in the present invention that the descending rate of the elastically restoring force of the first force descending section S2 is smaller than the descending rate of the elastically restoring force of the second force descending section S3, it doesn't compare every point of the first force descending section S2 with every point of the second force descending section S3, but compares the overall descending rates of the two sections. In FIG. 9 and FIG. 10, the elastically restoring force of the first force descending section S2 descends from the first length L1 to the second length L2 at approximately constant rate, so the length from the first length L1 to the second length L2 corresponds to a downward sloping straight line, and the slope of this downward sloping straight line is smaller than the slope of the downward sloping straight line corresponding to the second length L2 to the third length L3.

If the manufacture of the window blind 30 has a relatively larger tolerance, it may cause a relatively poorer buffering effect, making the user feel the bottom rail 32 suddenly declining and hard to be controlled when pulling the bottom rail 32 downward. The above-described design of the descending rate of the elastically restoring force of the first force descending section S2 being smaller than the descending rate of the elastically restoring force of the second force descending section S3 can improve the buffering effect of the window blind 30 to avoid the problem that the bottom rail 32 suddenly declines and is hard to be controlled when being pulled downward.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A variable-force coil spring comprising a central hole and a band coiled from the central hole outward, the band comprising an inner end located in the central hole, an outer end, and a plurality of sections arranged from the outer end toward the inner end successively, the plurality of sections, from the outer end toward the inner end in order, comprising:
an outer end section from the outer end to a first length;
a first force descending section generating gradually descending elastically restoring force from the first length to a second length;
a second force descending section generating gradually descending elastically restoring force from the second length to a third length; and
a force maintaining section generating maintained elastically restoring force from the third length to a fourth length.

2. The variable-force coil spring as claimed in claim 1, wherein the force maintaining section generates consistent elastically restoring force from the third length to the fourth length.

3. The variable-force coil spring as claimed in claim 1, wherein the force maintaining section generates gradually ascending elastically restoring force from the third length to the fourth length, and an ascending rate of the elastically restoring force of the force maintaining section is smaller than a descending rate of the elastically restoring force of the first force descending section and smaller than a descending rate of the elastically restoring force of the second force descending section.

4. The variable-force coil spring as claimed in claim 1, wherein a descending rate of the elastically restoring force of the first force descending section is larger than a descending rate of the elastically restoring force of the second force descending section.

5. The variable-force coil spring as claimed in claim 1, wherein a descending rate of the elastically restoring force of the first force descending section is smaller than a descending rate of the elastically restoring force of the second force descending section.

6. The variable-force coil spring as claimed in claim 5, wherein the elastically restoring force of the first force descending section non-linearly descends from the first length to the second length first quickly and then slowly.

7. A pulling cord control device comprising:
a housing;
at least one cord winding wheel and a coil spring winding wheel, which are disposed in the housing capably of rotating each other; and
a variable-force coil spring comprising a central hole and a band coiled from the central hole outward, the band comprising an inner end located in the central hole, an outer end, and a plurality of sections arranged from the outer end toward the inner end successively, the variable-force coil spring being arranged to be affected by an external force to be wound onto the coil spring winding wheel from an initial installed status, when the variable-force coil spring is in the initial installed status, the outer end of the band being disposed on the coil spring winding wheel, the sections of the band wound onto the coil spring winding wheel from the initial installed status in order comprising:
a first force descending section generating gradually descending elastically restoring force from a first length to a second length;
a second force descending section generating gradually descending elastically restoring force from the second length to a third length; and
a force maintaining section generating maintained elastically restoring force from the third length to a fourth length.

8. The pulling cord control device as claimed in claim 7, wherein the pulling cord control device further comprises a coil spring sleeving wheel; the at least one cord winding wheel, the coil spring winding wheel and the coil spring sleeving wheel are disposed in the housing capably of rotating each other; the variable-force coil spring is sleeved onto the coil spring sleeving wheel.

9. The pulling cord control device as claimed in claim 7, wherein the force maintaining section of the variable-force coil spring generates consistent elastically restoring force from the third length to the fourth length.

10. The pulling cord control device as claimed in claim 7, wherein the force maintaining section of the variable-force coil spring generates gradually ascending elastically restoring force from the third length to the fourth length, and an ascending rate of the elastically restoring force of the force maintaining section is smaller than a descending rate of the elastically restoring force of the first force descending section and smaller than a descending rate of the elastically restoring force of the second force descending section.

11. The pulling cord control device as claimed in claim 7, wherein a descending rate of the elastically restoring force of the first force descending section of the variable-force coil spring is larger than a descending rate of the elastically restoring force of the second force descending section.

12. The pulling cord control device as claimed in claim 7, wherein a descending rate of the elastically restoring force of the first force descending section of the variable-force coil spring is smaller than a descending rate of the elastically restoring force of the second force descending section.

13. The pulling cord control device as claimed in claim 12, wherein the elastically restoring force of the first force descending section of the variable-force coil spring non-linearly descends from the first length to the second length first quickly and then slowly.
